(19) United States
(12) Patent Application Publication
(10) Pub. No.: US 2026/0043957 A1
(43) Pub. Date: Feb. 12, 2026

(54) SPEAKER DEVICE

(71) Applicant: Y.E. Hub Armenia LLC, Yerevan (AM)

(72) Inventors: Grigory ANNENKOV, Moscow (RU); Nikolaj LOZINSKIJ, Sevastopol (RU); Artur MAKAUSKAS, Zelenograd (RU); Aleksey ROPYANOY, Moscow (RU); Svetlana SOKOLOVA, Moscow (RU); Andrei SEMENOV, Irkutsk (RU); Jianzhong OU, Moscow (RU); Xiaoli TAN, Moscow (RU)

(21) Appl. No.: 19/283,047

(22) Filed: Jul. 28, 2025

(30) Foreign Application Priority Data
Aug. 12, 2024 (RU) 2024123126

(51) Int. Cl. F21V 8/00; H04R 1/02

(52) U.S. Cl. CPC G02B 6/0055; H04R 1/02

(57) ABSTRACT

A speaker device is provided. The speaker device comprising: a device body having: a top surface, a reflecting surface extending at least partially downwardly from an exterior edge of the top surface, at least one wall at least partially overlapping with the reflecting surface, an aperture being defined between the exterior edge of the top surface and a top edge of the at least one wall, a light source disposed in an interior of the device body, and a lightguide disposed in the interior of the device body, the lightguide extending at least partially between the light source and the aperture; and the reflecting surface, the light source, the lightguide, and the at least one wall being arranged such that light emitted by the light source: travels through the lightguide to be incident on the reflective surface; reflects off the reflecting surface; and exits the speaker device through the aperture.

### CROSS-REFERENCE

The present application claims priority to Russian Patent Application No. 2024123126, entitled “SPEAKER DEVICE”, filed Aug. 12, 2024, the entirety of which is incorporated herein by reference.

### TECHNICAL FIELD

The present technology relates generally to loudspeakers, and more particular to loudspeakers implemented as a smart speaker and light indicators thereof.

### BACKGROUND

Broadly speaking, a loudspeaker (also, referred to herein as a “speaker device”) is a device including an enclosure and drive units capable of converting an electrical audio signal into a respective sound.

For example, such as speaker device can be implemented as a voice-activated personal assistant (also known as “smart speaker”, such as Amazon™ Alexa™, Google™ Home™, Yandex™ Alisa™, and the like) that is configured to execute voice commands of users, following a specific wake-up word (such as “Alexa”, “OK, Google”, and “Privet, Alisa”, respectively). For example, such commands can include, without limitation: (i) queries for information retrieval on the Internet relating, for example, to weather forecast, stock prices, best places to visit in Spain; or (ii) launching certain application on other electronic devices associated with a given user, such as a smart phone, for example, and executing specific requests related to such applications. For example, the given user can submit a request reading “Hey Google, play some lounge music”, and the speaker device can be configured to activate an audio-streaming application in order to execute the request. Also, in case where a given device is part of a smart home system, the user voice commands can include commands relating to switching on/off home appliances, lighting, closing/opening the binds, and the like.

Typically, such speaker devices can include various light indicators, such as Light Emitting Diodes (LED)-based light indicators. These indicators can, for example, indicate the current status of the speaker device, such as “active”, “stand-by”, or “error”.

In another example, these indicators can be configured to visualize sounds generated by the speaker device, such as device-generated answers of the speaker device to user queries or the music played back by the speaker device. In yet another example, such light indicators can be used additionally to the main lighting systems of a space where the speaker devices is located, for example, for esthetic purposes-such as for creating a specific light ambience or light accents in the space.

One of the challenges associated with the light indicators of these speaker devices can be that the light emitted thereof may not be sufficiently noticeable to the user from different viewing angles. In other words, at certain angles, the light indicator of the speaker device, while being on, may falsely appear to the user of the speaker device not emitting any light. In another example, the light emitted by the light indicator may appear to the user not bright enough, which could make it challenging to notice such light from a distance.

Accordingly, this may cause certain discomfort to the user interacting with the speaker device. For example, if the user has not noticed the indication that the speaker device has received the given command or the current status of the device being “error”, they can thus keep on submitting one and the same voice command to the speaker device. This may considerably affect the user experience of the user from interacting with the speaker device and other products and services associated therewith.

Certain approaches to tackle the above-identified problem have been proposed in the prior art.

Chinese Utility Model Application Publication No.: 205,017,495-U, published on Feb. 3, 2016, assigned to Shenzhen Grandsun Electronics Co Ltd, and entitled “BLUE TEETH SOUND BOX,” discloses a blue tooth sound box including a housing and light indications set installed therein-a concentric LED along the perimeter of the blue tooth sound box. The sidewall of the housing can be equipped with an LED ring. The light from the LEDs mounted on the printed circuit board can be directed from the light guide to the light guide ring to increase the scattering angle of the light source.

United States Patent No.: 11,693,488-B2, issued on Jul. 4, 2023, assigned to Apple Inc., and entitled “VOICE-CONTROLLED ELECTRONIC DEVICE,” discloses a voice-controlled electronic device that includes a device housing having a longitudinal axis bisecting opposing top and bottom surfaces and a side surface extending between the top and bottom surfaces. The device can further include one or more microphones disposed within the device housing and distributed radially around the longitudinal axis; a processor configured to execute computer instructions stored in a computer-readable memory for interacting with a user and processing voice commands received by the one or more microphones and first transducer and second transducers configured to generate sound waves within different frequency ranges.

### SUMMARY

It is one of the objects of the present technology to ameliorate at least some of the inconveniences present in the prior art.

Non-limiting embodiments of the present technology are directed to a specific configuration of an exit aperture of the light indicator of the speaker device. More specifically, the developers have appreciated that a specific ratio between a depth and height of the exit aperture may help direct the emitted light at a wider angle outside of the device, which, in turn, may make the light emission of the light source more noticeable and visible to the user.

Also, the developers have designed a lightguide for directing the light from the light source to the exit aperture that has specific transversely extending protrusions configured to diffuse the light passing therethrough. This may allow for more uniform intensity distribution of the emitted light, which may thus make the output light of the speaker device equally noticeable to the user from different viewing angles.

More specifically, in accordance with one broad aspect of the present technology, there is provided a speaker device. The speaker device comprises: a device body. The device body has: a top surface, a reflecting surface extending at least partially downwardly from an exterior edge of the top surface, at least one wall at least partially overlapping with the reflecting surface, an aperture being defined between the exterior edge of the top surface and a top edge of the at least one wall, a light source disposed in an interior of the device body, and a lightguide disposed in the interior of the device body, the lightguide being in optical communication with the light source, the lightguide extending at least partially between the light source and the aperture; and the reflecting surface, the light source, the lightguide. The at least one wall are arranged such that light emitted by the light source: travels through the lightguide to be incident on the reflective surface; reflects off the reflecting surface; and exits the speaker device through the aperture. The aperture has a height and a depth defining an aspect ratio, the aspect ratio being within a range from about 0.96 to about 1.53.

In some embodiments, the aspect ratio of the aperture is about 1.24.

In some embodiments, the aspect ratio of the aperture is about 1.19.

In some embodiments, the height of the aperture is within a range from about 4.35 mm to about 5.35 mm.

In some embodiments, the depth of the aperture is within a range from about 3.5 mm to about 4.5 mm.

In some embodiments, the height of the aperture is within a range from about 4.35 mm to about 5.35 mm; and the depth of the aperture is within a range from about 3.5 mm to about 4.5 mm.

In some embodiments, a portion of the device body defining the reflecting surface is at least partially translucent for light emitted by the light source; a first portion of light emitted by the light source propagates through the lightguide and is reflected by the reflecting surface; and a second portion of light emitted by the light source is transmitted through the portion of the device body defining the reflecting surface.

In some embodiments, the second portion, prior to being transmitted through the portion of the device body defining the reflecting surface, is transmitted through a sidewall of the lightguide.

In some embodiments, the sidewall of the lightguide defines at least one transversely extending protrusion configured for diffusing light passing therethrough; and the second portion, prior to being transmitted through the portion of the device body defining the reflecting surface, propagates through the at least one transversely extending protrusion.

In some embodiments, the light source comprises at least one light emitting diode (LED).

In some embodiments, a cross section of a portion of the device body defining the reflecting surface is defined by a spline curve intercepting the height and the depth of the aperture.

In some embodiments, a maximum curvature of a portion of the device body defining the reflecting surface is about 0.46 mm⁻¹.

In accordance with another broad aspect of the present technology, there is provided a speaker device. The speaker device comprises a device body. The device body has: a control panel having an outer face and an inner face, a reflecting surface extending at least partially transversely from an exterior edge of the inner face of the control panel, at least one wall at least partially overlapping with the reflecting surface, an aperture being defined between the exterior edge of the inner face and a closest longitudinal edge of the at least one wall, a light source disposed in an interior of the device body, and a lightguide disposed in the interior of the device body, the lightguide being in optical communication with the light source, the lightguide extending at least partially between the light source and the aperture. The reflecting surface, the light source, the lightguide, and the at least one wall are arranged such that light emitted by the light source: travels through the lightguide to be incident on the reflective surface; reflects off the reflecting surface; and exits the speaker device through the aperture. The aperture having a height and a depth defining an aspect ratio, the aspect ratio being within a range from about 0.96 to about 1.53.

As used herein, the term “about” in the context of a given value or range refers to a value or range that is within 10%, preferably within 5%, and more preferably within 1% of the given value or range.

For purposes of this application, terms related to spatial orientation, such as forwardly, rearwardly, upwardly, downwardly, left, right, and the like, are as they would normally be understood by a user or user of the device. Terms related to spatial orientation when describing or referring to components or sub-assemblies of the device, separately from the device should be understood as they would be understood when these components or sub-assemblies are mounted to the device.

Further, it should be expressly understood that the terms related to the spatial orientation listed above should be interpreted, in the context of the present specification, as depicted in the provided drawings.

Implementations of the present technology each have at least one of the above-mentioned aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, side perspective view of a speaker device, in accordance with certain non-limiting embodiments of the present technology;

FIG. 2 is a partial vertical cross section of the speaker device of FIG. 1 including a first embodiment of a light indicator, in accordance with certain non-limiting embodiments of the present technology; and

FIG. 3 is a partial vertical cross section of a speaker device including a second embodiment of the light indicator, in accordance with other non-limiting embodiments of the present technology.

### DETAILED DESCRIPTION

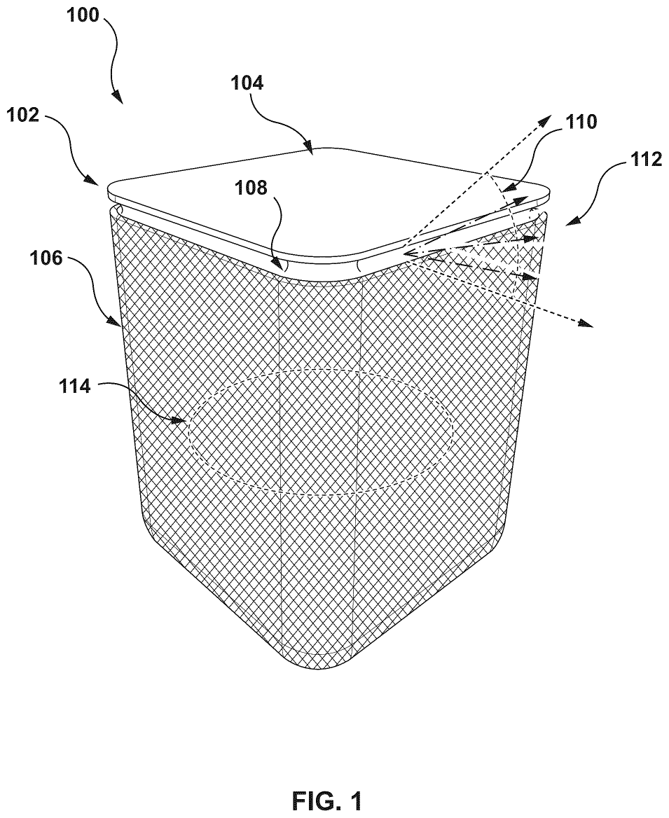

Referring initially to FIG. 1, there is depicted a perspective view of a speaker device 100, in accordance with certain non-limiting of the present technology. The speaker device 100 can be positioned by a user thereof on a flat support surface, such as a desk (not depicted), for example. Broadly speaking, in some non-limiting embodiments of the present technology, the speaker device 100 can be configured to convert electrical signals into respective sounds within a predetermined audio spectrum, such as that corresponding to a range appreciable by the human ear. For example, the speaker device 100 can be configured to reproduce songs and/or other audio feeds, which the user of the speaker device 100 wishes to listen to.

In additional non-limiting embodiments of the present technology, the speaker device 100 can be configured to reproduce the respective answers in response to predetermined spoken utterances and/or haptic interactions of the user of the speaker device 100 in a vicinity thereof. More specifically, in these embodiment, the speaker device 100 can be implemented as a smart speaker executing a virtual assistant application. For example, the virtual assistant application may be implemented as an ALISA™ virtual assistant application provided by Yandex LLC of 16 Lev Tolstoy Street, Moscow, 119021, Russia. Use of other commercial or proprietary virtual assistant applications that can be pre-installed on the speaker device 100 is also envisioned.

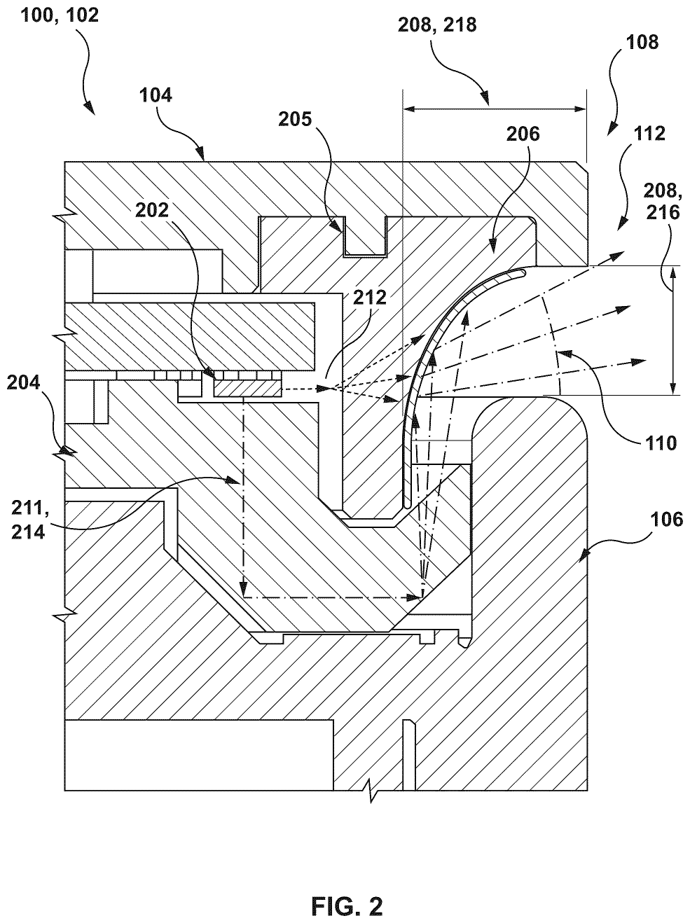

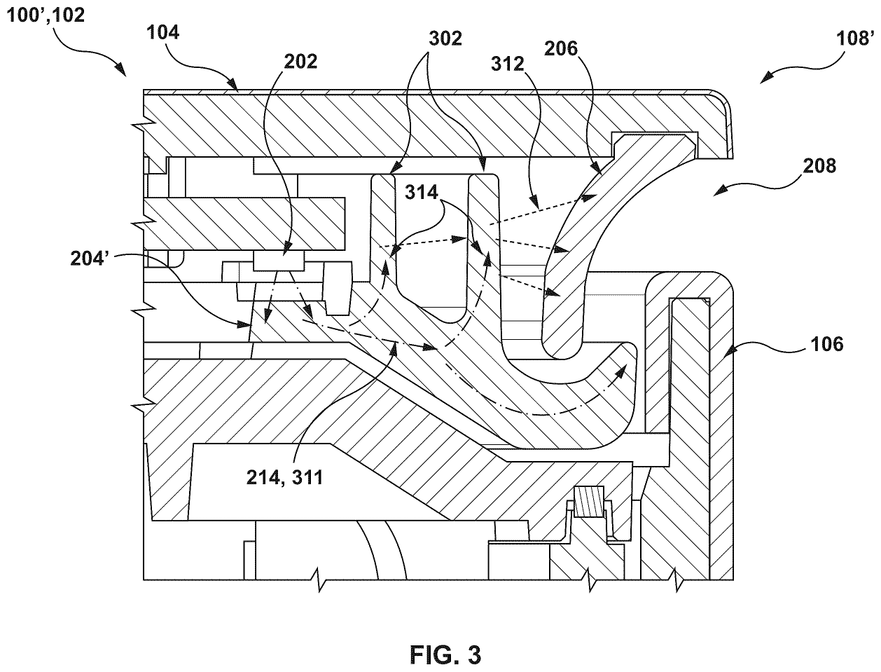

The speaker device 100 includes a device body 102 housing a plurality of hardware components of the speaker device 100, which will be described below. The device body 102 includes a top surface 104 and sidewalls 106 extending sufficiently perpendicularly, that is, downwardly in the orientation of FIG. 1, from the top surface 104. As will be better appreciated from FIGS. 2 and 3, in some non-limiting embodiments of the present technology, the top surface 104 can be coupled to the sidewalls 106 such that a portion of the top surface 104 overhangs the sidewalls 106. The device body 102 also includes a bottom surface (not shown), attached to the sidewalls 106 from an opposite side thereof to where the top surface 104 is attached to. In various non-limiting embodiments of the present technology, the bottom surface can either correspond to the shape of the top surface 104 or have any different shape.

As depicted in FIG. 1, the device body 102 of the illustrated embodiment has a generally square shape with rounded angles along a majority of the vertical extent of the device body 102. However, other configurations of the horizontal form of the device body 102 are also envisioned and can include, without limitation, a shape defined by a square, a rectangle or by any other convex, concave, regular, or irregular polygon with or without rounded angles, as well as a shape defined by a smooth closed curve, such as a circle or an ellipse, as an example.

In some non-limiting embodiments of the present technology, the top surface 104 can be implemented as a control panel of the speaker device 100. In this regard, the top surface 104 can be configured to accommodate certain control or branding elements of the speaker device 100. For example, the top surface 104 could be configured to receive (or otherwise define) actuators for controlling a volume of the sound output by the speaker device 100. In another example, the top surface 104 can be configured to receive or include a power actuator of the speaker device 100 for switching on and off the speaker device 100. In the illustrated embodiment, the top surface 104 is configured to accommodate a logo plate (not separately labelled), including, for example, one or more trademarks associated with the speaker device 100.

The sidewalls 106 define a speaker grid configured to convey the sound produced by a speaker 114 (shown schematically) of the speaker device 100 to an outside environment thereof. In some embodiments, to attain desired characteristics of the output sound, an acoustically transparent fabric (not depicted) can be applied to an inner surface of the sidewalls 106.

The device body 102, or portions thereof, can be made of various materials, including, without limitation, metal, plastic, fiberglass, wood, and others, as well as various combinations thereof.

In some embodiments, portions of the device body 102 could be integrally formed, such as by means of 3D printing. In other non-limiting embodiments of the present technology, at least one of: (i) the top surface 104 and (ii) the sidewall 106 of the device body 102 can be manufactured separately, such as by molding or casting, for example.

The speaker device 100 includes a plurality of hardware components housed in the device body 102. It should be noted that some of the plurality of hardware components have been omitted in the accompanying drawings for the sake of clarity and simplicity.

The plurality of hardware components of the speaker device 100 includes a processor (not depicted). When the speaker device 100 is assembled, the processor can be communicatively coupled with other inner components of the plurality of hardware components, for example, via respective wired communication links.

In some embodiments of the present technology, the processor may include one or more processors and/or one or more microcontrollers configured to execute instructions and to carry out operations associated with the operation of the speaker device 100, which includes, without limitation, instructions causing the execution of the virtual assistant application, instructions associated with receiving commands from the user of the speaker device 100, instructions associated with generating indications in response to receipt thereof, and the like. In various non-limiting embodiments of the present technology, the processor may be implemented as a single-chip, multiple chips and/or other electrical components including one or more integrated circuits and printed circuit boards. The processor may optionally contain a cache memory unit for temporary local storage of instructions, data, or additional computer information. By way of example, the processor may include one or more processors, or one or more controllers dedicated for certain processing tasks of the speaker device 100 or a single multi-functional processor or controller.

Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, such as the virtual assistant application, random access memory (RAM), and non-volatile storage.

Further, according to some non-limiting embodiments of the present technology, the plurality of hardware components of the speaker device 100 may include a communication module (not depicted). Such a communication module may be configured for implementing one of communication protocols (both wireless and wired) enabling the processor to be connected with other electronic devices or remote servers. Various examples of how the communication module may be implemented include, without being limited to, a Bluetooth™ communication module, a UART™ communication module, a Wi-Fi™ communication module, an LTET communication module, and the like.

According to the non-limiting embodiments of the present technology, communication between the processor and other ones of the plurality of inner hardware components, such as the communication module, as well as amongst each other, may be implemented by one or more internal and/or external buses (e.g. a PCI bus, universal serial bus, IEEE 1394 “Firewire” bus, SCSI bus, Serial-ATA bus, etc.), to which a respective one of the plurality of hardware components of the speaker device 100 is electronically coupled.

Further, the plurality of hardware components of the speaker device 100 installed within the device body 102 includes the speaker 114 (also referred to herein as a “speaker driver” or a “drive unit”) configured for reproducing a given sound within the predetermined audio spectrum. Generally speaking, the given sound is a combination of sound waves having various audio frequencies. For example, in those embodiments where the predetermined audio spectrum corresponds to the range appreciable by the human ear, the speaker 114 can be configured to generate sound waves in: (1) a low range from around 100 Hz to around 320 Hz (also referred to herein as a “bass frequency range”); (2) a middle frequency range from around 320 Hz to around 1280 Hz (also referred to herein as a “mid-frequency range”); and (3) a high range from around 1280 Hz to around 20400 Hz (also referred to herein as a “treble frequency range”).

Broadly speaking, the speaker 114 generally includes a concave membrane (also referred to herein as a “speaker diaphragm”) configured to convert a respective electrical audio signal, which can be received by the processor of the speaker device 100, for example, into the given sound. The concave membrane may be produced out of a thin material, such as polypropylene, polyether ether ketone, polycarbonate, biaxially-oriented polyethylene terephthalate (BoPET), and the like, for providing a desired level of sensitivity to the speaker 114.

Other hardware components that can be housed within the device body 102 will be apparent for those skilled in the art, and can include, without limitation: a power source for powering on the speaker device 100; and external ports, such as an audio jack or a Universal Serial Bus (USB™) port for transmitting electric audio signals representative of various sounds to be reproduced by the speaker 114.

It should be noted that, although also not depicted, for secure housing of each one of the plurality of hardware components of the speaker device 100 within the device body 102, an inner surface thereof can define and/or include all necessary mounting members.

According to the present technology, the speaker device 100 includes a light indicator 108. Broadly speaking, the light indicator 108 is configured to emit output light 112 from the speaker device 100 in response to predetermined indication instructions from the processor of the speaker device 100.

For example, according to some non-limiting embodiments of the present technology, the predetermined indication instructions may be for indicating a current status of the speaker device 100 having, for example, one of the following values: “READY,” “STAND-BY,” or “ERROR.”

In another example, the predetermined indication instructions can be for visualizing, by the light indicator 108, the output sound produced by the speaker device 100, such as machine-generated answers to user requests or played back music. In other words, in these embodiments, the processor of the speaker device 100 can be configured to cause the light indicator 108 to change at least one of a colour, an intensity, or a flashing pattern of the output light 112 in real time according to sound parameters, such as a frequency or an amplitude, of the output sound produced by the speaker 114 of the speaker device 100.

By doing so, the light indicator 108 can be practical to maintain a visual communication between the speaker device 100 and the user thereof. Thus, for a better user experience of the user from interacting with the speaker device 100, it is desired that the output light 112 emitted by the light indicator 108 be visible to the user at different values of a vertically-extending light output range 110 of the light indicator 108. A horizontally-extending light output range (not separately labelled) of the output light 112 is defined by a horizontal extension of the light indicator 108 along the sidewalls 106.

It should be expressly understood that although in the example of FIG. 1, the light indicator 108 extends along all of the sidewalls 106, substantially parallel to an exterior edge of the top surface 104, it may not be the case in each and every embodiment of the present technology. For example, in some non-limiting embodiments of the present technology, the light indicator 108 can extend along only one or two sidewalls of the sidewalls 106. In other non-limiting embodiments of the present technology, the light indicator 108 can extend along only a portion of a single one of the sidewalls 106. It is also contemplated that the light indicator 108 and the sidewalls 106 could be differently arranged, including such that the light indicator 108 is arranged at a different angle relative to the top surface 104.

Configuration and implementation of the light indicator 108, according to certain non-limiting embodiments of the present technology, will now be described.

With reference to FIG. 2, there is depicted a partial vertical cross section of the speaker device 100 demonstrating a first non-limiting embodiment of the light indicator 108 in accordance with some non-limiting embodiments of the present technology.

The light indicator 108 includes: (1) a light source 202 configured to produce light to be output by the light indicator 108; (2) a lightguide 204 configured to guide the light produced by the light source 202 towards the outside environment of the speaker device 100; (3) a vertically-extending wall 205 including an outer surface 206 configured to reflect light incident thereto from the lightguide 204 towards the outside environment of the speaker device 100 and hence referred to herein as a reflecting surface 206; and (4) an exit aperture 208, defined between the top surface 104 and the sidewalls 106, arranged to permit light from the reflecting surface 206 to exit to the outside environment of the speaker device 100. As it can be appreciated, a vertically-extending angular range over which the output light 112 propagates from the speaker device 100 defines the vertically-extending light output range 110 of the light indicator 108.

Each of the above-listed components of the light indicator 108 will now be described in greater detail.

### Light Source

The light source 202 is disposed within the device body 102 in optical communication with the lightguide 204 such that at least a portion of the light produced by the light source 202 enters the lightguide 204. For example, in the embodiment depicted in FIG. 2, the light source 202 is directed downwardly towards the lightguide 204, thereby enabling a first light portion 211 of the light emitted by the light source 202 to (i) enter the lightguide 204, (ii) travel therethrough to be incident on the reflecting surface 206 of the vertically-extending wall 205; (iii) reflect off the reflecting surface 206; and (iv) exit the speaker device 100 through the exit aperture 208, thereby forming the output light 112 of the light indicator 108.

In some non-limiting embodiments of the present technology, the output light 112 can be formed only by the first light portion 211 reflected off the reflecting surface 206. In other non-limiting embodiments of the present technology, as will become apparent from the description provided hereinbelow, the output light 112 of the light indicator 108 can also be formed by a second light portion 212 of the light emitted by the light source 202, which is transmitted through the vertically-extending wall 205 without entering the lightguide 204, and can further be combined with the first light portion 211.

Further, according to certain non-limiting embodiments of the present technology, the light source 202 is configured to emit the light at a one or more wavelengths of the visible light spectrum, generally considered from about 380 nm to about 750 nm. In some embodiments, the light source 202 could be configured to emit the light within a given wavelength range of the visible light spectrum, such as, without limitation, at least one of: (1) from about 380 nm to about 450 nm; (2) from about 450nm to about 485 nm; (3) from about 485 nm to about 500 nm; (4) from about 500 nm to about 565 nm; (5) from about 565 nm to about 590 nm; (6) from about 590 nm to about 625 nm; or (7) from about 625 nm to about 750 nm. For example, the given wavelength range can be selected to correspond to a selected colour of the emitted light. However, in another example, the given wavelength range can be selected to correspond to more than one colour of the emitted light.

Further, it is not limited how the light source 202 can be implemented. The light source 202 could be implemented as a light source of various types, such as one of: at least one incandescence lamp and at least one electric discharge lamp (such as a Neon, Argon, or Xenon lamp, for example). In the illustrated embodiment, the light source 202 is implemented as an electroluminescence light source, such as a light emitting diode (LED).

According to certain non-limiting embodiments of the present technology, in the embodiments where the light source 202 is implemented as one or more LEDs, the LED includes, depending on a desired wavelength range, for example, without limitation, one or more of: (1) an indium gallium nitride (InGaN) LED, configured to emit light between about 395 nm and about 530 nm; (2) an aluminum indium gallium phosphide (AlInGaP) LED configured to emit light between about 565 nm and about 645 nm; and (3) an aluminum gallium arsenide (AlGaAs) LED configured to emit light between about 660 nm and 900 nm.

In a specific non-limiting example, the light source 202 can have dominate wavelengths of about 615 nm, 522 nm, and 463 nm for the red, green, and blue colors, respectively. In this regard, the light source 202 can be of a YLS1615/2R1G3B/21/06-6-C type available from Y.LIN ELECTRONICS CO., LTD. of 6, Xinguang Road, phase III, Jinhe Industrial Zone, Zhangmutou town, Dongguan City, Guangdong Province, People's Republic of China. In this example, the light source 202 has a forward voltage from about 1.7 V to about 2.4 V and a reverse current of about 10 μA. It should be expressly understood that the light source 202 can be implemented in any other suitable equipment.

In some non-limiting embodiments of the present technology, the light source 202 can be configured to emit the light substantially in a given predetermined direction. In FIG. 2, for example, a propagation direction of the first light portion 211 is generally downwardly, substantially perpendicularly to the top surface 104 of the device body 102. In other non-limiting embodiments of the present technology, the light source 202 can be configured to emit the light in multiple directions, such as by scattering the emitted light therearound.

### Lightguide

Broadly speaking, the lightguide 204 is shaped and arranged such that the light passing therethrough undergoes total inner reflection until it exits the lightguide 204.

According to the non-limiting embodiments of the present technology, the lightguide 204 can be implemented as a transparent dielectric lightguide made from plastic or glass, as an example. Various implementations of the lightguide 204 can further include, without limitation, lightguides having different in geometry (such as planar or strip lightguides), lightguides different in refractive index distribution (such as step or gradient index lightguides), and lightguides made of different materials (such glass, polymer, or composite material). Also, it should be noted that in some embodiments, the lightguide 204 can also be implemented as an optical fiber lightguide without departing from the scope of the present technology.

As it can be appreciated from FIG. 2, a body of the lightguide 204 extends at least partially between the light source 202 and the exit aperture 208 to guide the light emitted by the light source 202 to an outer side (with respect to the inside of the device body 102) of the reflecting surface 206.

As is schematically depicted in FIG. 2, the lightguide 204 defines an optical path 214, extending through the body thereof, enabling the light emitted by the light source 202 to travel therefrom to the reflecting surface 206 of the vertically-extending wall 205.

With reference to FIG. 3, there is depicted a partial vertical cross section of a speaker device 100′ demonstrating a second non-limiting embodiment of the light indicator 108′. The speaker device 100′ differs from the speaker device 100 only in that the former, instead of the lightguide 204, includes an other lightguide 204′. Elements of the speaker device 100′ similar to those of the speaker device 100 retain the same reference numeral and will not be described in detail.

The speaker device 100′ includes one or more protrusions 302 (two protrusions in this example as illustrated) extending generally outwardly from a main body of the lightguide 204′. In the orientation of FIG. 3, the one or more protrusions 302 extend upwardly from the other lightguide 204, substantially perpendicular to the top surface 104. As illustrated, the one or more protrusions 302 are integrally formed with the other lightguide 204′. It is contemplated that the one or more protrusions 302 could be differently formed in some embodiments.

Thus, in the embodiment depicted in FIG. 3, the other lightguide 204′ defines, along with the optical path 214, additional optical paths 314, corresponding to the one or more protrusions 302, propagating from the other lightguide 204′. The one or more protrusions 302 are shaped and arranged to spread out light passing therethrough for further transmitting it to an inner surface (that is, that facing an interior of the device body 102) of the vertically-extending wall 205. In some non-limiting embodiments of the present technology, an outer surface of the lightguide 204′ can be configured to diffuse light incident thereto. To do so, the outer surface of the lightguide 204′ can be treated with a matte finish. Thus, in these embodiments, the one or more protrusions 302 are configured not only to spread out the light passing therethrough but also to diffuse it. In some non-limiting embodiments of the present technology, the matte finish can be a Verein Deutscher Ingenieure (VDI) surface finish.

Thus, as will be explained in greater detail below, in the embodiments where the one or more protrusions 302 includes a single protrusion, the output light 112 of the light indicator 108 can include: (i) a first internal light portion 311 travelling to the reflecting surface 206 of the vertically-extending wall 205, along the optical path 214; and (ii) a second internal light portion 312 travelling to the inner side of the vertically-extending wall 205, along the additional optical paths 314.

Accordingly, in some non-limiting embodiments, where there is only one protrusion 302, the second internal light portion 312 is the light that has passed through this single protrusion 302. However, where there are two or more protrusions 302, as depicted in FIG. 3, the second internal light portion 312 includes light that has passed through the one or more protrusions 302, as light from one protrusion 302 may be further spread out by subsequent protrusions along the additional optical paths 314.

### Reflecting Surface

The reflecting surface 206 of the vertically-extending wall 205 extends at least partially downward from the exterior edge of the top surface 104. As it can be appreciated from FIGS. 2 and 3, the reflecting surface 206 can partially overlap with the sidewalls 106 of the device body 102.

According to the non-limiting embodiments of the present technology, the reflecting surface 206 is configured to reflect light incident thereon. To that end, the reflecting surface 206 is treated with a reflective material, such as one of anodized aluminium; reflective thermoplastic, such as BoPET; aluminium foil; acrylic mirror; and others.

As mentioned above, the reflecting surface 206 is formed on an exterior of vertically-extending wall 205 which is at least partially translucent to permit transmission of light incident thereon from an inside of the device body 102, such as the second light portion 212 and/or the second internal light portion 312 mentioned above. By doing so, light incident on the inner surface of the vertically-extending wall 205 may pass through the reflecting surface 206 towards the exit aperture 208 to form at least part of the output light 112 of the light indicator 108. To that end, the vertically-extending wall 205 is manufactured from a transparent or semi-transparent material, such as glass, thermoplastic (such as acrylic), and the like. In a specific example, the vertically-extending wall 205 can be implemented as a semi-transparent mirror, the inner surface of which is configured to pass the light incident thereon through the vertically-extending wall 205, and the outer side is configured to reflect the light incident thereon. It is contemplated that the vertically-extending wall 205, on which the reflecting surface 206 is defined, could be formed from a non-transparent (opaque) material. In such embodiments, there will be generally no second internal light portion 212 and second internal light portion 312.

To more evenly distribute light reflected off and/or passed through the reflecting surface 206 along a height 216 of the exit aperture 208, the reflecting surface 206 has a curvature. For example, in some non-limiting embodiments of the present technology, a cross section of the reflecting surface 206 can be defined by a circular of elliptical arch intercepting the height 216 and a depth 218 of the exit aperture 208 of the light indicator 108. In other non-limiting embodiments of the present technology, the cross section of the reflecting surface 206 can be defined by a spline curve intercepting the height 216 and the depth 218 of the exit aperture 208. It should be expressly understood that other curves can also be used to define the cross section of the reflecting surface 206, including, without limitation, a Bezier curve, a B-spline, a Hermite spline, and others.

Also, in some non-limiting embodiments of the present technology, a value of the curvature of the reflecting surface 206 can be constant along the exit aperture 208.

In other non-limiting embodiments, the value of the curvature of the reflecting surface 206 can vary along the height 216 of the exit aperture 208. According to certain non-limiting embodiments of the present technology, a maximum value of the curvature of the reflecting surface 206 can be 0.46 mm⁻¹ (that is, a minimum radius of curvature being 2.17 mm). Other curvature values of the reflecting surface 206 are also envisioned.

### Exit Aperture

With continued reference to FIGS. 2 and 3, the exit aperture 208 of the light indicator 108 is defined between the exterior edge of the top surface 104 and a closest longitudinal edge of the sidewalls 106, that is, a top edge thereof in the orientation of FIG. 2.

As it is best seen in FIG. 2, the exit aperture 208 has (1) the height 216, defined by a distance between the exterior edge of the top surface 104 and the top edge of the sidewalls 106; and (2) the depth 218 defined by a maximum distance between the top edge of the sidewalls 106 and the reflecting surface 206. The height and depth 216, 218 of the exit aperture 208 define an aperture aspect ratio. In some non-limiting embodiments of the present technology, the aspect ratio can be within a range between about 0.96 and about 1.53. In one specific example, the aspect ratio can be about 1.24. In another specific example, the aspect ratio can be about 1.19.

Developers of the present technology have appreciated that these values of the aspect ratio between the height and depth 216, 218 in combination with the curvature of the reflecting surface 206 may allow widening the vertically-extending light output range 110 of the light indicator 108 to 45 degrees, which further allows for better visibility of the output light 112 to the user of the speaker devices 100 and 100′.

Thus, according to certain non-limiting embodiments of the present technology, specific values of the height and depth 216, 218 of the exit aperture 208 can be selected such that a given value of the aspect ratio provided above is satisfied. For example, in some non-limiting embodiments of the present technology, the height 216 of the exit aperture 208 can be within a range between about 4.35 mm and 5.35 mm; and the depth 218 of the exit aperture can be within a range between about 3.50 mm and 4.50 mm. Other values for the height and depth 216, 218 of the exit aperture 208 satisfying the given value of the aspect ratio therebetween non-exhaustively given above are also envisioned.

To summarize, in some non-limiting embodiments of the present technology, directed to the speaker device 100 having the light indicator 108 including the lightguide 204, which are described above with reference to FIG. 2, the light source 202, the lightguide 204, and the reflecting surface 206 can be arranged within the speaker device 100 such that: the first light portion 211, emitted by the light source 202: (i) enters the lightguide 204; (ii) propagates therethrough, along the optical path 214 of the lightguide 204, to the reflecting surface 206; (iii) reflects off the reflecting surface 206, thereby forming the output light 112 that exits the speaker device 100 through the exit aperture 208 within the vertically-extending light output range 110.

The developers of the present technology have appreciated that, in these embodiments, the configuration of the exit aperture 208 described above allows widening the vertically-extending light output range 110 of the light indicator 108 up to 45 degrees. This may allow for better noticeability of the output light 112 to the user of the speaker device 100 and hence improvement of their user experience with the speaker device 100.

In other non-limiting embodiments of the present technology (for example, when the light source 202 is configured to scatter the emitted light therearound), the output light 112 of the light indicator 108 can also be formed by the second light portion 212. More specifically, in these embodiments, the second light portion 212 transmits through the reflecting surface 206 from the inner surface of the vertically-extending wall 205 and combines with the first light portion 211 reflected off the reflecting surface 206, thereby forming the output light 112.

The second light portion 212 passing through the reflecting surface 206 may thus allow for increased and/or more evenly distributed intensity of the output light 112 along the height 216 of the exit aperture 208, which may further allow for more consistent visibility of the output light 112 to the user of the speaker device 100.

In some non-limiting embodiments of the present technology, directed to the speaker device 100′, the light indicator 108′ of which includes the other lightguide 204′, that are described above with reference to FIG. 3, the light indicator 108′ receives light from the additional optical paths 314 for the light emitted by the light source 202. More specifically, in these embodiments, the other lightguide 204′ defines the optical path 214 for the first internal light portion 311 to form at least part of the output light 112, similarly to the first light portion 211 as described above with reference to FIG. 2. Further, via the one or more protrusions 302, there are defined the additional optical paths 314 along which light deviates from the optical path 214 and enters the one or more protrusions 302. The one or more protrusions 302 spread out the entering light, thereby forming the second internal light portion 312. Further, the second internal light portion 312 transmits through the reflecting surface 206 of the vertically-extending wall 205; and combines with the first internal light portion 311 having reflected off the reflecting surface 206, thereby forming the output light 112 of the light indicator 108.

It is also contemplated that, in the embodiment depicted in FIG. 3, light propagating from the light source 202 and through the reflecting surface 206 without passing through the lightguide 204 could contribute to the output light 112, in addition to the second internal light portion 312.

According to the developers of the present technology, the one or more protrusions 302 may allow spreading out (and thus removing) so-called light spots within a vertical cross section of the output light 112, thereby providing for even more uniform intensity thereof along the height 216 of the exit aperture 208.

Modifications and improvements to the above-described implementations of the present technology may become apparent to the person skilled in the art. The foregoing description is intended to be exemplary rather than limiting. The scope of the present technology is therefore intended to be limited solely by the scope of the appended claims.

What is claimed is:

1. A speaker device comprising:
a device body having:
a top surface,
a reflecting surface extending at least partially downwardly from an exterior edge of the top surface,
at least one wall at least partially overlapping with the reflecting surface,
an aperture being defined between the exterior edge of the top surface and a top edge of the at least one wall,
a light source disposed in an interior of the device body, and
a lightguide disposed in the interior of the device body, the lightguide being in optical communication with the light source, the lightguide extending at least partially between the light source and the aperture; and
the reflecting surface, the light source, the lightguide, and the at least one wall being arranged such that light emitted by the light source:
travels through the lightguide to be incident on the reflective surface;
reflects off the reflecting surface; and
exits the speaker device through the aperture,
the aperture having a height and a depth defining an aspect ratio, the aspect ratio being within a range from about 0.96 to about 1.53.

2. The speaker device of claim 1, wherein the aspect ratio of the aperture is about 1.24.

3. The speaker device of claim 1, wherein the aspect ratio of the aperture is about 1.19.

4. The speaker device of claim 1, wherein the height of the aperture is within a range from about 4.35 mm to about 5.35 mm.

5. The speaker device of claim 1, wherein the depth of the aperture is within a range from about 3.5 mm to about 4.5 mm.

6. The speaker device of claim 1, wherein:
the height of the aperture is within a range from about 4.35 mm to about 5.35 mm; and
the depth of the aperture is within a range from about 3.5 mm to about 4.5 mm

7. The speaker device of claim 1, wherein:
a portion of the device body defining the reflecting surface is at least partially translucent for light emitted by the light source;
a first portion of light emitted by the light source propagates through the lightguide and is reflected by the reflecting surface; and
a second portion of light emitted by the light source is transmitted through the portion of the device body defining the reflecting surface.

8. The speaker device of claim 7, wherein:
the second portion, prior to being transmitted through the portion of the device body defining the reflecting surface, is transmitted through a sidewall of the lightguide.

9. The speaker device of claim 8, wherein:
the sidewall of the lightguide defines at least one transversely extending protrusion configured for diffusing light passing therethrough; and
the second portion, prior to being transmitted through the portion of the device body defining the reflecting surface, propagates through the at least one transversely extending protrusion.

10. The speaker device of claim 1, wherein the light source comprises at least one light emitting diode (LED).

11. The speaker device of claim 1, wherein a cross section of a portion of the device body defining the reflecting surface is defined by a spline curve intercepting the height and the depth of the aperture.

12. The speaker device of claim 1, wherein a maximum curvature of a portion of the device body defining the reflecting surface is about 0.46 mm⁻¹.

13. A speaker device comprising:
a device body having:
a control panel having an outer face and an inner face,
a reflecting surface extending at least partially transversely from an exterior edge of the inner face of the control panel,
at least one wall at least partially overlapping with the reflecting surface,
an aperture being defined between the exterior edge of the inner face and a closest longitudinal edge of the at least one wall,
a light source disposed in an interior of the device body, and
a lightguide disposed in the interior of the device body, the lightguide being in optical communication with the light source, the lightguide extending at least partially between the light source and the aperture, and
the reflecting surface, the light source, the lightguide, and the at least one wall being arranged such that light emitted by the light source:
travels through the lightguide to be incident on the reflective surface;
reflects off the reflecting surface; and
exits the speaker device through the aperture; and
the aperture having a height and a depth defining an aspect ratio, the aspect ratio being within a range from about 0.96 to about 1.53.
